(19) United States
(12) Patent Application Publication
(10) Pub. No.: US 2006/0212344 A1
(43) Pub. Date: Sep. 21, 2006

(54) AUTOMATED PARKING LOT SYSTEM, METHOD, AND COMPUTER PROGRAM PRODUCT

(76) Inventors: J. Cooper Marcus, Berkeley, CA (US); Neil Rosenblatt, Natick, MA (US)

Correspondence Address: MICHAEL E. WOODS;PATENT LAW OFFICES OF MICHAEL E. WOODS, 112 BARN ROAD, TIBURON, CA, 94920-2602, US

(21) Appl. No.: 11/308,131

(22) Filed: Mar. 8, 2006

Related U.S. Application Data
(60) Provisional application No. 60/659,841, filed on Mar. 9, 2005.

(51) Int. Cl. G07B 15/00; G08G 1/14

(52) U.S. Cl. 705/13; 340/932.2

(57) ABSTRACT

A system, method, computer program product and propagated signal for an automatic parking system. The system includes a sensing subsystem for detecting an occupancy status of a vehicle parking space, said sensing subsystem providing a real-time occupancy status signal for said vehicle parking space wherein said occupancy status signal includes an occupied mode and an unoccupied mode; a communications subsystem, coupled to said sensing subsystem, for transmitting said occupancy status signal; and a management subsystem for receiving said occupancy status signal, said management subsystem processing a parking transaction for said vehicle parking space automatically upon a mode change of said occupancy status signal. A method includes automatically opening a parking transaction upon detecting an occupation of a parking space or area and automatically closing a parking transaction upon detecting a vacation of a parking space or area. Additional elements may include an authorization system and a notification system. The methods include identified parking methods for detecting automatically changes in an occupancy status of one or more parking spaces or areas and automatically initiating/closing, as appropriate, parking transactions responsive to appropriate detected changes in occupancy status signals associated with each of the one or more parking spaces, as well as methods of making and using the disclosed systems. Computer program products and propagated signals include computer-executable instructions for implementing the systems and methods.

### CROSS REFERENCE TO RELATED APPLICATIONS

This application claims the benefit of and incorporates by reference for all purposes, the entire disclosure of U.S. Provisional Patent Application No. 60/659,841, filed on 9 Mar. 2005 and entitled “Automated Parking Lot System.”

### BACKGROUND OF THE INVENTION

The invention relates to methods, systems, computer program products, and propagated signals for managing vehicle parking, and more particularly to methods, systems, computer program products, and propagated signals that automatically detect parking space occupancy status and associate authorization status with individual parking spaces.

There are many parking systems and methods implemented today for managing vehicle parking. Rules and regulations are commonplace for vehicular parking. Such rules may include absolute prohibitions, such as areas in which no parking is permitted, or the rules may include conditional prohibitions, such as permit-only parking, free limited duration parking, and fee-based parking. Metered parking is also typical on public roadways. In addition to various types of parking restrictions, the rules may be enforced by either private or public agencies.

Monitoring parking that is restricted in any of the above manners is costly and time consuming. Typically, a person must visually inspect all of the restricted spaces periodically, regardless of whether cars are actually there. This task becomes more difficult when the spaces are distributed over a large area, such as a city block or a large, multi-level parking garage. While parking monitoring systems have been described, they are typically limited to the detection of the presence or absence of a vehicle in a particular location. Such systems are employed, for example, in garages to provide occupancy statistics, and to direct vehicles to open spaces. As a significant disadvantage, these systems do not apply parking restriction rules to determine whether a particular vehicle is parked in a spot where it should not be. As a further disadvantage, so-called ‘smart’ parking systems of the prior art employ transducers hardwired into a parking detection network. These systems cannot be retrofitted to existing parking structures or infrastructures. Still further, these systems typically include mechanical ingress/egress limitators at limited access points to ensure compliance with the parking license(s) in effect for the particular lot. These systems also frequently employ a fee-structure that either requires advance payment for some period of time making the parker overestimate the parking duration (and thus overpayment) to ensure compliance or the system implements a payment system that quantizes the parking period into large units that also results in overpayment, or both.

There remains a need for an automated parking management/enforcement system that can be adapted to existing parking facilities while providing simplified, efficient and automatic tracking, auditing, and authorization.

### BRIEF SUMMARY OF THE INVENTION

Disclosed is a system, method, computer program product and propagated signal for an automatic parking system. The system includes a sensing subsystem for detecting an occupancy status of a vehicle parking space, said sensing subsystem providing a real-time occupancy status signal for said vehicle parking space wherein said occupancy status signal includes an occupied mode and an unoccupied mode; a communications subsystem, coupled to said sensing subsystem, for transmitting said occupancy status signal; and a management subsystem for receiving said occupancy status signal, said management subsystem processing a parking transaction for said vehicle parking space automatically upon a mode change of said occupancy status signal. The processing includes automatically opening a parking transaction upon detecting an occupation of a parking space or area and automatically closing a parking transaction upon detecting a vacation of a parking space or area. Additional elements may include an authorization system and a notification system.

The methods includes identified parking methods for detecting automatically changes in an occupancy status of one or more parking spaces or areas and automatically initiating/closing, as appropriate, parking transactions responsive to appropriate detected changes in occupancy status signals associated with each of the one or more parking spaces, as well as methods of making and using the disclosed systems. Computer program products and propagated signals include computer-executable instructions for implementing the systems and methods.

The present invention provides an automated parking management/enforcement system that can be adapted to existing parking facilities while providing simplified, efficient and automatic tracking, auditing, and authorization. The system includes detection devices associated with parking spaces/areas (such as for example magnetometers and other sensing systems), data communications (wired/wireless) and a communications based authorization system (e.g., a payment system when authorization includes payment provisions) to monitor occupancy of parking spaces/areas within a monitored area, determine a length of time of each occupancy mode (for example how long a spot is occupied or unoccupied) collect correct payment amounts when appropriate and deliver notices and data to enforcement, auditing, and parkers in appropriate ways.

The present invention includes a number of advantages over conventional systems, including no requirement for onsite personnel or mechanical devices, no prepayment, no action required upon departure, optional dynamic pricing, a unique numbering system, and a potential for no sensors. Further, the present scales well for adding aggregations of one or more small numbers of parking spaces/areas into an automated system.

No moving mechanical devices, such as gates or ticket printers, or card scanners, are required for operation, such as for collection of parking fees and the like. Embodiments of the system, method, computer program product and propagated signal provide a highly accurate system for recognizing a presence of vehicles and recording with a high degree of accuracy an amount of time a vehicle has been present/absent and able to accordingly apply authorization rulesets which may include automatic fee determination and payment.

Without requiring prepayment or other onsite electronic machinery for collecting fees for prepayment by the parker, the present system simplifies installation requirements. Additionally, when implemented in this fashion, it is advantageous to pay automatically when parking is over and the payment may be based upon the precise amount of time the vehicle was parked. Without the mechanical gates, ingress/egress controls are not necessary so exiting a lot may be made much simpler and convenient to a user. Associating a payment account with the parking transaction permits the exact amount to be deducted when the parking transaction is closed automatically upon vacating a monitored parking space.

In addition, the optional dynamic pricing is adaptive and may be based upon quantified information available to the system, both internal and external. The unique numbering system, when used, provides simplified unambiguous association of a parking space to an authorization for the parking space.

An ability to scale is also an important aspect of the present invention. Many conventional systems are not efficient for small numbers (one or other small numbers) of parking spaces distributed geographically, particularly when different rulesets for use and authorization are applicable and in the event that the space or spaces are available for public fee-based parking for limited periods. The lots must either have many mechanical gates, personnel or special walls and routing paths established to limit ingress/egress. The present invention easily permits a person to derive some revenue or otherwise make a single parking space available at certain times without significant capital expenditures or other infrastructure investment or inconveniences.

### BRIEF DESCRIPTION OF THE DRAWINGS

FIG. 1 is a block diagram of a parking management system;

FIG. 2 is a block diagram of a representative parking management system shown in FIG. 1;

FIG. 3 is a flowchart of a first parking management process, such as that may be implemented by the systems shown in FIG. 1 and FIG. 2, for example; and

FIG. 4 is a flowchart of a second parking management process, such as that may be implemented by the systems shown in FIG. 1 and FIG. 2, for example.

### DETAILED DESCRIPTION OF THE INVENTION

The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

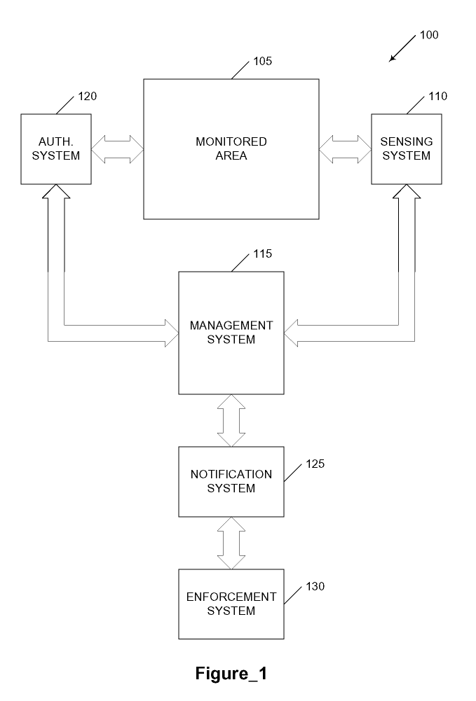

FIG. 1 is a block diagram of a parking management system 100. System 100 includes a monitored area 105 having one or more vehicle parking spaces. A sensing system 110 detects an occupancy status of the vehicle parking spaces of monitored area 105 and provides occupancy status signals to a management system 115. Some systems 100 will include an authorization system 120 for receiving information regarding monitored area 105 and providing it to management system 115 as described in more detail below. Additionally, system 100 may include a notification system 125 communicated to management system 115 that may, in turn, provide one or more notifications to an enforcement system 130 regarding authorized and/or unauthorized occupancy status of the vehicle parking spaces in monitored area 105. System 100 has a great versatility in arrangement, and while the specific preferred embodiments set forth below are representative implementations, these implementations are not exhaustive and other arrangements are within the scope of the present invention.

Monitored area 105 is a collection of the one or more physical vehicle parking spaces, delineated in some fashion, which are monitored for occupancy status (including determinations of authorization for occupancy). These physical vehicle parking spaces may be wholly or partially contiguous or non-contiguous and include (as a partial non-exhaustive representative list), parking spaces for automobiles, aircraft, bicycles, motorcycles, trucks, boats, trains, and other motorized and non-motorized vehicles and the like. The vehicle parking spaces may include paved and non-paved areas in the vicinity of security-sensitive facilities such as for example bridges, power plants, dams, buildings, airports, seaports, and other areas and the like.

While system 100 parses monitored area 105 into one or more delineated physical vehicle parking spaces, the parking spaces themselves need not be visibly delineated. In some embodiments, each parking space is assigned a unique identifier (e.g., a unique number or unique code of alphanumeric characters)—unique within system 100—with such identifiers visibly and unambiguously associated with each parking space such as for example by providing the identifier on a sign physically associated with the parking space or directly painted or otherwise recorded on the parking surface of the parking space. In some instances, a parking space is a larger geographic expanse than that required to contain a single vehicle. For example, a parking space may include a less-formally delineated area such as a lot of contiguous spaces, a region of a town, city, or other land representation, which may have a unique identifier. There are alternative views of monitored area 105, including that monitored area 105 is a single large lot made up of the collection of individual vehicle parking spaces or that monitored area 105 is a collection of parking lots, each of size one, as well as “lots” of different size. System 100 is able to apply different parking management rules on a space-by-space and space aggregation-by-aggregation basis as further explained below, thus the concept of a parking lot is different than used in many conventional senses.

Unique identification system may identify each parking space or area in monitored area 105. In a preferred embodiment, it is desirable that this unique identification system be implemented as a unique number to facilitate entry of the identifier (when authorization information is provided as described below) by a mobile telephone keypad. In some cases, alphanumeric may also be used as some mobile systems provide for alphanumeric characters. A parker may also be able to be given authorization for parking in a particular space, area, or region through a pre-approved authorization process, which may be negotiated ahead of time prior to parking, such as for example a day or more in advance of parking. Such authorization (advance or otherwise) may be valid for a set period in minutes, days, weeks, or other units. Verification that the parker has a right to park as attempted may be achieved by identification of a vehicle identification (e.g., a car license plate, car description, phone call to the system, printed identification code which may be printed by a home computer, remote printer, or the like and may include a bar code or other identifying number or letter sequence, a transponder, RFID configuration or other notification to a monitoring live or automated agent) directly or indirectly. As described herein, a preferred way (though not exclusive) is to automatically associate an authorization communication from a parker to an occupancy status and to determine a space-by-space/area-by-area authorization.

Sensing system 110 is an arrangement of sensors for detecting an occupancy status of the parking spaces of monitored area 105. Sensing system 110 may include (as a partial non-exhaustive representative list) one or more wireless or wired sensors employing magnetic, light, sound, pressure, temperature, sonar, radar, RFID, sensing methods and the like. Each delineated parking area, whether an individual vehicle parking space or collection of spaces as determined by its configuration in system 100, is monitored independently in “real-time” for changes in an occupancy status signal that includes an occupied mode and an unoccupied mode. When a vehicle occupies one of the delineated areas, its associated occupancy status signal changes from unoccupied to occupied. Similarly, when a vehicle vacates one of the delineated areas, its associated occupancy status signal changes from unoccupied to occupied. In the present, real-time means a detection mechanism (whether polled or interrupt driven or otherwise) is sufficiently frequent (based upon the vehicle type and delineated parking area/space) to ensure that multiple occupations/vacations by one or more vehicles are detectable. In some instances, this may be a sensor update every few seconds, but in other instances it may be a minute or several minutes between sensing updates. What is preferably avoided in certain implementations is a situation where one vehicle vacates a space and another vehicle occupies the same space between sensor updates so that an occupancy status (occupancy time and duration for example) of the previous vehicle is not properly attributed to the previous vehicle and attributed to the current vehicle. In some instances it may not be necessary to distinguish between occupancy statuses of previous and current vehicles, thus the “real-time” sensing period may be reduced when necessary or desired.

Sensing system 110 includes the following representative non-limiting embodiment. Each delineated parking space/area is provided with one or more wireless parking sensors for generating the occupancy status signal. When the parking space has a unique identifier, the occupancy status signal is unambiguously associated with the identifier so system 100 develops a set of occupancy status signals, each clearly associated with a parking space/area. These sensors may be CMOS magnetometers or other compact, low-power magnetic, pressure, infrared, or other sensor or the like. Additionally, other systems may include video cameras using pattern recognition or satellites with visual, infrared radar, lidar, or other sensing systems. In other implementations, sensing system 110 may include a video recording device, potentially working in coordination with a vehicle/motion detection system or software. Each wireless parking sensor may include a low-power RF transmitter/transceiver or other communication system. The sensors may be daisy-chained or arranged in parallel with a receiver (such as for example a wireless data gateway). The daisy-chain configuration permit multi-hop data routing with one sensor passing radio traffic/data from one sensor to another towards the data gateway. This has an advantage in extending a range of individual sensors, so for example, not every sensor would need to be within direct communication range. In other embodiments, a communications portion of sensing system 110 may include a computer or computer-like device coupled to a modem or other data communication mechanism (including but not limited to) systems employing cellular phone technology, paging technology, Internet technology, non-cellular direct line communication, and the like.

Each sensor preferably includes a low-power microcontroller, a unique ID number, a battery or other source of power (e.g., DC/AC line or solar-generated or chemistry-generated current or the like including radiation-powered battery sources). A rugged housing suitable for the intended environmental conditions, including whether vehicles will contact (e.g., “run over”) the sensor. Typically each sensor is arranged physically proximate (i.e., installed in or very near) to each parking space to which it is associated and which it monitors, but such arrangements are not invariably required, particularly for certain implementations and sensor types. Sensors are appropriate for the type of vehicle or vehicles intended to be monitored. Certain sensors may develop further occupancy status information, such as magneto sensors may be able to distinguish between a large vehicle and a small vehicle based upon a magnetic profile. Other sensors, for other vehicle types, may similarly produce other occupancy status conditions or modes appropriate in the particular context. Alternatively, in some cases the sensor may be a fully wired system (or hybrid), including for instance a loop wire communicated to a sensing device. The sensor or components thereof may also be buried to some depth under the pavement. In some implementations such installations may be less expensive.

The wireless data gateway, when included in sensing system 110 such as when the sensors are not arranged/configured for long distance communication) includes a low-power receiver (example a radio transceiver) that is compatible with the transmission paradigm of the sensors. The wireless data gateway may employ wireless data radio (GPRS, GSM, 2-way paging, cellular control channel, WiFi, or other “longer range” industry standard wireless communications protocol and the like.) It too, preferably includes a low-power microcontroller, a battery or other source of power (e.g., DC/AC line or solar-generated or chemistry-generated current or the like including radiation-powered battery sources). A rugged housing suitable for the intended environmental conditions of the sensor. Typically each gateway is arranged physically proximate (i.e., installed in or very near) to each collection of sensors to which it is associated and which it communicates such as in an elevated position on a wall or pole near the monitored physical vehicle parking spaces, but such arrangements are not invariably required, particularly for certain implementations and sensor types.

A role of these sensors in cooperation with the data gateway, collectively defining sensing system 110, is to generate the appropriate modes for the occupancy status signals for the vehicle parking spaces of monitored area 105.

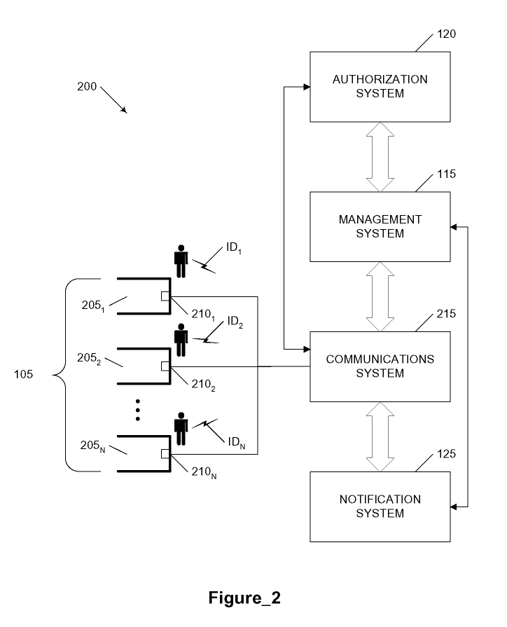

In at least one embodiment of the present invention, no sensing system 110 is implemented. In such embodiments, for example, parking may be purchased through a prepaid system based upon amount of time, such as parking for 1 hour, 2 hours, 24 hours, 1 month, or other time period. In this case notification of intent to purchase rental time may be made through contacting an organization in charge of monitoring the parking area chiefly through a telephone call, but also through other data transmission such as email, text, or other message, written notification or other method and the like. A communications system (e.g., as shown in FIG. 2 and described below) communicates (wirelessly or wired or combination thereof) information from the sensing system to the management system.

Management system 115 receives the occupancy status signals from sensing system 110. There are many different ways that the occupancy status signals, including changes to one or more occupancy status signals, may be implemented, appropriate for the type of vehicle and type of monitoring desired. Some systems 100 are adapted for generating parking revenue from occupancy of certain parking spaces, some are adapted for promoting security of a monitored area, some are for generating audit information of use of parking spaces, some are to ensure that vehicles are actually present in locations that they are expected to be at appropriate times, still others are adapted to measure/ensure compliance with other parking rules and regulations (such as for example one free hour free parking in a merchant lot). Some of these representative but non-exhaustive ways are described below. Management system 115 uses the occupancy status signals to implement an automatic space-by-space parking system with the possibility that each vehicle parking space in monitored area 105 potentially has a different implementation purpose.

Some of these purposes may require authorization, and when needed, management system 115 includes or cooperates with an authorization system 120. There may be multiple authorization rulesets, static or dynamic or combination, implemented by management system 115 and authorization system 120. For example, authorization system 120 may include communications capabilities and devices allowing an occupier of a vehicle parking space or monitored area 105 to develop and communicate an authorization to management system 115. Authorization method may include (again, this is a partial non-exhaustive representative list)—including:

a) reception of communication from the occupying party or thing that includes identification information and occupied space/area information. The identification information would then be checked by the central system for authorization to occupy the given occupied area;

b) reception of communication from the occupying party or things that includes payment information and occupied area information. Valid payment information could grant authorization to occupy the given occupied space/area; and

c) identification of the occupying party or thing from sensing system 110. Such identification could be checked by management system 115 for prior or categorical authorization to occupy the given occupied space or area.

For example, in one embodiment authorization system 120 includes a payment by phone (PBP) or similar system having one or more of a computerized interactive voice response (IVR) and associated databases that:

a) identifies a caller (e.g., by caller ID or through caller keying in an identifier—a phone number or other);

b) determines whether the caller has previously opened a parking account or has previously used or attempted to use services—when not, request payment information (e.g., appropriate credit or debit information or account creation information for establishing some form of payment account);

c) requests that the caller provide the parking space/area identifier that they are occupying (or in the case of an advance reservation, the space or area that they intend to occupy in the future and optionally, a day or date range for occupying the space or area for a particular identified duration—e.g., March 9, 24 hours);

d) informs the caller of the price or rate to be paid for the requested occupation condition (if any); and/or

e) requests that the caller acknowledge responsibility for paying the fee when appropriate in the requested fashion (including prepay or postpaid through credit card, debit card, other account or the like).

In another preferred embodiment, a caller acknowledges payment for a space or area simply by keying in a space or area number. In such case the price or rules for parking may not be read over the phone but may have been published elsewhere. In another embodiment the payer acknowledges responsibility to pay for parking simply through phoning a specific number (or number plus internal extension) and having their phone number recognized through caller ID. In such case, the caller does not necessarily make an additional step of verifying through further pressing of buttons. In a final system payment would be made by calling to a special number (e.g., a typical 900 number or other pay number) which is charged to a phone account. Implementation of features of this embodiment may require less customer effort or time than other configurations.

Every implementation may not include all of a) through e) but may include one or more of the component features. In some cases, different features will be available to different callers at different times, with management system 115 able to dynamically determine authorization and ruleset conditions based upon many factors and conditions. For example in some embodiments, parking prices/rates are changed automatically and remotely based upon quantitative algorithmic processing of appropriate data. For instance, such would be accomplished as notification of payment price may be exclusively or non-exclusively informed to users through the communications system interface at the time the user parks. This provides a useful aspect to those implementations of the present invention because an ability to remotely/non-remotely, automatically, and dynamically change prices may improve/maximize an ability to produce/enhance revenues in line with potential parkers' willingness to pay, based upon aspects such as local weather, time of day, year, special events, changing traffic patterns, amount to which surrounding parking spaces have become full (e.g., based upon system occupancy status), amount of traffic based upon other data collection and processing techniques, such as overall traffic flow in an area, collecting from GPS enabled car navigation systems or the like.

In other embodiments, an entity other than an IVR may replace the IVR system. This may be a live operator who performs similar functions, may be a computerized database booking system handled over the Internet, a paging or text messaging system, or some other database system, or may be a separate system entirely. A goal of this part of system 100 is that the parker identifies her/him/itself and provides authorization for payment (when required by the then currently applicable authorization ruleset) or other method for authorization of occupancy or vacancy. In some implementations, it is necessary to obtain authorization to vacate a parking space, such as for example in fleet management operations and the like.

Additionally, authorization system 120/management system 115 includes a computerized transaction system that:

a) stores a variety of pricing models (various dollar amounts, lengths of time, days, and other variations), which may be updated periodically or changed manually;

b) stores a list that associates sensor identifiers with parking space/area numbers;

c) records when a space/area becomes occupied;

d) records when a space/area becomes unoccupied;

e) determines a correct fee (if any) for the parking occupancy transaction;

f) charges/debits the parker/account holder the correct fee at the appropriate time;

g) provides a receipt for the transaction via text messaging, email, mail, or other system or the like; and

h) sends a notification (see notification system below) to another component of system 100 or to an outsourced partner when a space/area has a particular predetermined occupancy and authorization condition (e.g., a space is occupied but there has been no corresponding authorization event within a predetermined period after occupancy began).

It is a goal of this function of system 100, when implemented, to match an authorization with an occupancy condition, whether present or future authorization/occupancy. Additionally, when an occupancy status (e.g., a presence or an absence of a vehicle) requires a particular authorization, system 100 ensures compliance with necessary authorization/lack of authorization with occupancy status information.

There are many situations and conditions when system 100 advantageously provides information to various functions and personnel regarding various occupancy and authorization parameters. System 100 may include a notification system 125 for providing one more of these notifications. For example, if/when management system 115 determines authorized or unauthorized occupancy or vacation (which may represent a departure of a vehicle parked in a space/area but may also include monitoring for verification that a vehicle is not present in general) of a given monitored area 105, or one of its space or areas, communication capabilities are optionally provided that provide notice of such status to devices or personnel, local or remote. In obtaining information on occupancy status, a message may automatically be sent from a detection location to a central data location or a query may be sent from a central data location requesting information from the detection apparatus regarding vehicle status/occupancy status.

Information about authorized or unauthorized occupancy or vacation of a given monitored area, space and/or area, and/or information about changes in occupancy and/or authorization status are communicated to various personnel or devices, such as for example the following partial non-exhaustive representative list)—sending of text, numeric, voice, fax, email, or other electronic or non-electronic message to a mobile or fixed, wired or wireless, communication device. For example, a computerized text messaging system (SMS) that:

a) sends a desired (static or dynamically constructed) text message to one or more mobile phones or other communication device, system, or process such for example a PDA, computer email account, or other communications portal;

b) stores pre-determined messages or message templates and inserts data, such as for example from the IVR system and/or the computerized transaction system described above, prior to issuing a message or notification.

For example, this may be for a purpose of sending receipts, sending notifications, sending marketing messages, sending notifications of time or price changes or other and the like. The systems and subsystems described above, including the IVR, transaction, and notification systems are typically resident on one or more computer servers and associated telephone network interconnections in one or more central locations.

System 100 may also optionally include an enforcement system 130 to ensure compliance, on a space-by-space or area-by-area basis of occupancy status and authorization status. Depending upon the type of parking space or area, the authorization ruleset(s) in effect, the type of vehicle and occupancy status, different types of enforcement mechanisms may be used. For example, an unauthorized occupation of a parking space may result in vehicle immobilization or towing. An unauthorized vacation of a parking space may initiate a notice to law enforcement agencies.

Below is a partial non-exhaustive representative list of representative classes of embodiments of system 100 in operation. This list includes three preferred embodiments: 1) private passenger vehicle (e.g., automobile) parking; 2) aircraft parking; and 3) sensitive facility security monitoring.

Automobile Parking

System 100 automatically opens a parking transaction upon detecting a change of an occupancy status of one of the parking spaces. The parking transaction is identified as an authorized parking transaction upon successful receipt of an authorization communication properly identifying the appropriate parking space—which preferably needs to be received within some appropriate time after opening the parking transaction. The parking transaction is automatically closed simply by driving the automobile away—with the appropriate charge (if any) assessed. In this configuration, it is possible to charge for actual parked time used, to the minute if desired in addition to use of other models. In this system, no mechanical gates or ingress/egress constriction is needed to enforce compliance with the parking rules. Each lot may have multiple, unmanned and ungated entrances and exits greatly increasing the user experience with parking system 100.

One arrangement for system 100 for this implementation includes monitored area 105 including one or more automobile parking spaces, clearly delineated, and uniquely coded among all parking spaces in system 100, with appropriate “human consumable” codes clearly visible to the parker and unambiguously associated with the parking spaces. Sensing system 110 includes an arrangement of sensors for remotely identifying an occupancy status (e.g., an occupied mode or an unoccupied mode) of each of the parking spaces. Authorization system 120 includes a system that receives communication from a parker, the communication identifying both the occupied space and appropriate authorization (e.g., a payment method or in some cases a particular parker has implicit authorization for one or more spaces without express payment required). For example, this may be embodied in an IVR phone system, operator based call center, an Internet based system, or the like. Notification system 125 includes one or more methods that notify enforcement system 130 when unauthorized parking space occupancy occurs. Thus the enforcement system may ticket, boot, tow, or in some other manner seek remedy or compensation from the unauthorized occupancy. Additionally, notification system 125 provides notice to the parker of the accumulated charges assessed after they vacate the parking space. Payment upon leaving—system 100 implemented in this way is advantageous in that users may in this embodiment pay only for a precise amount of parking time consumed. In other words in addition to other prepayment options, the vehicle driver may after notifying system 100 through a telephone or other communications system, then proceed to park. A charge would occur after the vehicle vacates the space, system 100 charges an account in some form (credit, debit, reduction of prepaid amount). While other post payment options may exist, this option is advantageous in that onsite personnel, tickets, coins, tokens, and the like are not necessary and the driver needs to make no additional action (other than driving away from a parking space) since payment is an automatic deduction from an appropriate account as authorized.

Aircraft Parking

Monitored area 105 includes one or more aircraft parking spaces, clearly delineated, and uniquely coded, with codes clearly visible to the pilot or parking personnel. Sensing system 110 includes an arrangement of sensors for remotely identifying an occupancy status (e.g., an occupied mode or an unoccupied mode) of each of the parking spaces. Authorization system 120 includes a system that receives communication from a parker, the communication identifying both the occupied space and appropriate authorization (e.g., a payment method or in some cases a particular parker has implicit authorization for one or more spaces without express payment required). For example, this may be embodied in an IVR phone system, operator based call center, an Internet based system, or the like. Notification system 125 includes one or more methods that notify enforcement system 130 when unauthorized parking space occupancy occurs. Thus the enforcement system may ticket, boot, tow, or in some other manner seek remedy or compensation from the unauthorized occupancy. Additionally, notification system 125 provides notice to the parker of the accumulated charges assessed after they vacate the parking space.

Sensitive Facility Security Monitoring

In this embodiment, the systems and subsystems described herein are used to monitor occupancy by motor vehicles of areas surrounding sensitive facilities like bridges, power plants, chemical plants, ports and the like. Monitored area 105 includes one or more parking areas, which are typically NOT clearly delineated, but include unique coding, with codes made available to the parker (when parking may be authorized as some locations may never have authorized parking). Sensing system 110 includes an arrangement of sensors for remotely identifying an occupancy status (e.g., an occupied mode or an unoccupied mode) of each of the parking spaces. In this embodiment, it is optionally advantageous to also have sensing system 110 also determine a particular vehicle or vehicle class (e.g., a large truck or regular passenger vehicle). Authorization system 120 includes a system that receives communication from a parker, the communication identifying both the occupied space and appropriate authorization (e.g., a payment method or in some cases a particular parker has implicit authorization for one or more spaces without express payment required). For example, this may be embodied in an IVR phone system, operator based call center, an Internet based system, or the like. Authorization system 120 may further include a list of authorized parkers and additionally compare the parker authorization against the authorization list to confirm appropriate authorization. Notification system 125 includes one or more methods that notify enforcement system 130 when unauthorized parking space occupancy occurs. Thus the enforcement system may expeditiously ticket, boot, tow, or in some other manner seek remedy or compensation from the unauthorized occupancy. Similarly notification system 125 may notify enforcement system 130 when an removal (authorized or unauthorized) of a vehicle has occurred from the monitored area.

FIG. 2 is a block diagram of a representative parking management system 200 shown in FIG. 1. System 200 includes a plurality of uniquely numbered vehicle parking spaces 205ₓ, x=1 to N, each monitored individually by a sensor 210ₓ, x=1 to N (collectively sensors 210 make up the sensing system shown in FIG. 1). Each sensor 210x is associated with a space 205x for generating an occupancy status signal, these signals including in the preferred embodiment at least an occupied mode and an unoccupied mode. Sensors 210 communicate the occupancy status signals (or signals derived therefrom such as occupancy status change signals or the like) to management system 115 via a communications system 215. Each parker, represented by the silhouette, associated with an occupied space 205ₓ submits an authorization communication (IDₓ) to management system 115 through communications system 215 and authorization system 120. Communications system 215 supports both the sensing system and the authorization system, when authorization is implemented. The authorization communication preferably includes the unique identifier associated with the parked space and is matched up to the sensed occupancy at management system 115, as determined from the sensing system.

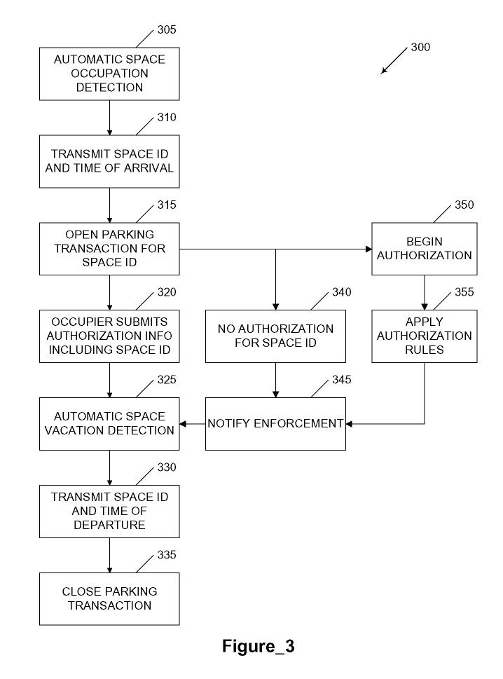

FIG. 3 is a flowchart of a first parking management process 300, such as that may be implemented by the systems shown in FIG. 1 and FIG. 2, for example, and including an authorization requirement. Process 300 includes a sequence of blocks. Block 305 identifies automatic space occupation detection, such as when a vehicle enters into monitored area 105, specifically into a specific parking space or parking area. Block 310, following block 305, transmits a space identifier and time of occupancy of the space occupancy event detected in block 305. Next, block 315 automatically opens a parking transaction automatically in response to the transmitted detected occupancy. At this point, process 300 may branch depending upon how authorization (if any) is handled—First a sequence from block 315, block 320 through block 335 is described in a first operational mode for receipt of the appropriate authorization communication. Second (and later), an alternate branch of block 340, block 345, and then block 325 through block 335 is described for a second operational mode for when an appropriate authorization communication is not received. Third (and later), an alternate branch of block 350 and then block 355 through block 335 is described for a third operational mode for when an appropriate authorization communication is not necessary at a beginning of a transaction.

Block 320 includes submission by the occupier of an authorization communication that includes the space identifier. Appropriate authorization information is associated with the opened parking transaction for the detected occupied space. Note that in some implementations submission of an explicit authorization communication is not always necessary, such as when the occupancy rules permit free but limited use (e.g., up to one hour parking that is free). In some instances, the authorization is limited in some respect (e.g., duration) and occupancy rules for the authorization determine that a previously authorized parking event becomes unauthorized. In such case, block 320 includes a notification to enforcement (e.g., block 340 as described below). Next, block 325 maintains the opened parking transaction in an open, pending state until block 325 detects a change in the occupancy status of the parking space, such as when the occupancy status signal changes from occupied to unoccupied. Block 325 detects automatically the vacation of the parking space associated with the open parking transaction and then process 300 advances to block 330 to transmit the space identifier and time of vacation (departure). Process 300, at block 335, then closes the open parking transaction assessing the appropriate parking fee, if any, for the person by accessing the account identified in the authorization communication. The parking transaction in this case is automatically closed and the person billed the appropriate amount responsive to leaving the space and the duration that the vehicle was parked in the space.

However, when no authorization is received after block 315 within a predetermined period (and occupancy rules for the occupied space or area require an authorization), say five to ten minutes after a detection of space occupancy, process 300 branches to block 340 from block 315 in which process 300 determines that no authorization has been provided for the detected occupied parking space. Thereafter, process 300 at block 345 notifies enforcement (if any) to remedy the unauthorized parking condition and process 300 branches back to block 325 to wait for space vacation. However, unless a user belatedly initiates block 320 and submits the authorization communication, process 300 closes the parking transaction without charging a fee when the unauthorized parking condition is remedied. Submission of valid authorization information returns process 300 to the sequence of block 320 through block 335.

In the third case when no authorization is received after block 315 and occupancy rules for the occupied space or area do not require an advance authorization, process 300 branches to block 350 from block 315 in which process 300 begins with an authorization for the detected occupied parking space. Thereafter, process 300 at block 355 may periodically or otherwise apply occupancy rules against the parking transaction (such as in the case for example that all parkers are authorized for one free hour) but thereafter additional authorization may be required (if at all permitted) to exceed the initial authorization period. After applying applicable occupancy rules (if any) process 300 may notify enforcement at block 345 (when implemented) to remedy any instances of unauthorized parking and process 300 branches back to block 325 to wait for space vacation. However, unless a user belatedly initiates block 320 and submits the authorization communication, process 300 closes the parking transaction without charging a fee when the unauthorized parking condition is remedied. Submission of valid authorization information returns process 300 to the sequence of block 320 through block 335.

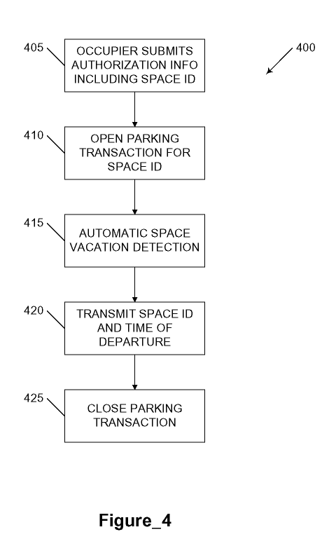

FIG. 4 is a flowchart of a second parking management process 400, such as that may be implemented by the systems shown in FIG. 1 and FIG. 2, for example, for performing an advance reservation of a parking space. Process 400 includes a sequence of blocks, block 405 through block 425. Process 400 begins at block 405 with a person desiring to reserve a parking space submits an authorization communication identifying a specific parking space or area. The identification can be a specific parking space or a group of spaces identified for this purpose.

Next, process 400 (block 410) opens a parking transaction for the reserved space or area. Depending upon the terms of the advance reservation (such as for example how far in advance the reservation is made), fees may begin to accrue immediately or a set reservation fee may be assessed. In some embodiments, process 400 may activate signage associated with the reserved spot indicating that the parking space is reserved. Additionally, process 400 will ensure that there no other parker receives authorization to use a reserved spot, notifying a user trying to park in a reserved space that the space is, in fact, reserved and they must move to another space. In other implementations, process 400 reserves a space, but not a specific space, to ensure that all reservations may be filled. In this implementation, it is necessary to link a person with a reservation to a parking space after occupancy is detected. Next, block 415, detects for vacation of the reserved space. Process 400 transmits the space identifier and time of departure (block 420) and closes the parking transaction of the reservation (block 425).

While the above is a general discussion of some operational embodiments, the following includes another operational description of a functional example of a preferred embodiment. A customer drives or maneuvers a vehicle into a parking space/area. The sensing system (e.g., the wireless parking sensor) associated with that space notes a change in the local magnetic field (or other property(ies) monitored by the sensor indicating a presence of a vehicle in the associated space. The wireless parking sensor communicates exception information and the sensor ID to the wireless data gateway, and in turn the gateway communicates the exception notification and sensor ID to the transaction server that is part of the management system. The management system opens a new parking transaction, noting time of customer arrival (via occupancy status signal (e.g., the exception notification) or a time of a phone call communicating authorization information in the parking space/area associated with the sensor ID.

The customer dials the pay-by-phone systems (e.g., from their mobile personal communicator such as wireless phone) and is identified by caller ID or other manual or automatic recognition system. When the customer is not identified by caller ID (e.g., caller ID is unavailable) customer is requested to enter identification information sufficient to enable payment. Identification may include keying in a pre-assigned account number, speaking into an Interactive Voice Response system, talking with a live operator, entering new account information into the database, or other. Alternatively the customer may send an email or other electronic message (e.g., an SMS message) to notify of an occupation of a particular space and/or to send authorization information for the particular space. The pay-by-phone system determines whether the customer has an existing or valid account that can be used. When not, the customer is requested to enter credit or debit card information to open an account or to provide other suitable identifying information. The pay-by-phone system requests that the customer enter the number or unique code of the parking space/area that they are occupying. The management system (e.g., through the transaction server) now associates the customer, the authorization account, with the space number. The system performs some testing to ensure that valid information is entered, including such simple tests as detecting whether the space identified by the customer is in fact recently occupied and does not already have associated authorization information, among other possible tests. The customer may be informed/notified verbally or electronically via messaging of some type (e.g., a text message to their mobile communicator) of the cost or rate of the parking. The user is directed to hang up, and in some instances the system may not charge the customer if they vacate the parking space within a predetermined period after receiving the rate. The pay-by-phone is enabled in some systems to send the customer an SMS, email, fax, or other notifying message noting that they have arrived in parking space number “N” at a given time and will be charged according to the applicable and notified pricing model. Alternatively, the notice may indicate that the customer has purchased parking rights for a given amount of time in a given geographic or space delineated area.

Sometime later, the customer returns to the parking space and vacates the parking space by moving the vehicle. The wireless parking sensor associated with that space notes the change in the local magnetic field (or otherwise detects an occupancy status change indicating a vacation of the vehicle previously parked). The sensor communicates exception information and the sensor ID to the data gateway, the data gateway in turn communicates the exception information and the sensor ID to the management system. The management system automatically closes the parking transaction of the parking transaction associated with the vacated space, noting time of customer departure. The pay-by-phone system charges the customer's stored payment method according to time space was occupied and applicable pricing model. The pay-by-phone system sends a transaction receipt to the customer via SMS, or other notification system, including but not limited to email, fax, or the like.

As noted above, in the event that a customer does not call the pay-by-phone system to communicate the authorization information, the management system waits a predetermined period (e.g., five minutes) and then notes that an occupied space does not have a corresponding associated authorization communication. Thereafter the management system sends notification to enforcement, which may include a citation, request for a towing vehicle, or application of a vehicle boot until the situation is resolved. In the event that the sensing system determines that the vehicle vacates the parking space, the management system uses the notification system to update the enforcement process that enforcement is not needed.

Additional alternate embodiments include use of a wireless parking sensor, a data gateway and a subset of the pay-by-phone functions to simply monitor an area/space for a presence/absence of a vehicle, and to send notification when an exception occurs. In this model there may be no per-use financial transaction.

Embodiments of the present invention include offers of free or discounted customer parking by distributing unique “pass codes” to entities near the parking space or spaces, the entities distribute the pass codes to their customers, customers parking in the space call to initiate a parking transaction as described above. When entering the customer ID or space ID, if the customer uses the pass code and it is valid when used, the system employs an alternate pricing model including a discount of some type, including some period of “free parking” or the like. The pay-by-phone is configured to not require payment for parking during certain periods—for instance a business may want to offer free parking to customers during business hours, with no requirements for customer to call the pay-by-phone. However, after business hours, the business derives revenue from use of its parking spaces by activating the pay-by-phone financial transaction process for after hours use. Other use of free time for paying for parking may be used in the following situation. An owner of one set of monitored spaces may receive free minutes or hours of paid parking in the greater set of parking spaces in the entire system (or within a specific geographic area, such as a city or state). The owner of these spaces may receive free parking time (in time, monetary, or point increments) based on membership in the system, in association with the amount of time that customers park in the enrolled spaces/areas or by other grading system. Similar free time amounts may distributed to other parkers or potential parkers for other reasons.

In some alternate embodiments, after having purchased rights to park in a given delineated area, the parker may print out some sort of coded permission release or token that may be placed in the window of the vehicle to verify permission to park in an area. Other notifying methods may be used, including writing of a code number or other. In this case, the parker may purchase rights to park for a given time through some system that may be a phone, fax, Internet based system or the like.

The system, method, computer program product, and propagated signal described in this application may, of course, be embodied in hardware; e.g., within or coupled to a Central Processing Unit (“CPU”), microprocessor, microcontroller, System on Chip (“SOC”), or any other programmable device. Additionally, the system, method, computer program product, and propagated signal may be embodied in software (e.g., computer readable code, program code, instructions and/or data disposed in any form, such as source, object or machine language) disposed, for example, in a computer usable (e.g., readable) medium configured to store the software. Such software enables the function, fabrication, modeling, simulation, description and/or testing of the apparatus and processes described herein. For example, this can be accomplished through the use of general programming languages (e.g., C, C++), GDSII databases, hardware description languages (HDL) including Verilog HDL, VHDL, AHDL (Altera HDL) and so on, or other available programs, databases, nanoprocessing, and/or circuit (i.e., schematic) capture tools. Such software can be disposed in any known computer usable medium including semiconductor, magnetic disk, optical disc (e.g., CD-ROM, DVD-ROM, etc.) and as a computer data signal embodied in a computer usable (e.g., readable) transmission medium (e.g., carrier wave or any other medium including digital, optical, or analog-based medium). As such, the software can be transmitted over communication networks including the Internet and intranets. A system, method, computer program product, and propagated signal embodied in software may be included in a semiconductor intellectual property core (e.g., embodied in HDL) and transformed to hardware in the production of integrated circuits. Additionally, a system, method, computer program product, and propagated signal as described herein may be embodied as a combination of hardware and software.

One of the preferred implementations of the present invention is as a routine in an operating system made up of programming steps or instructions resident in a memory of a computing system, during computer operations. Until required by the computer system, the program instructions may be stored in another readable medium, e.g. in a disk drive, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Internet, when required by the user of the present invention. One skilled in the art should appreciate that the processes controlling the present invention are capable of being distributed in the form of computer readable media in a variety of forms.

Any suitable programming language can be used to implement the routines of the present invention including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed as new and desired to be protected by Letters Patent of the United States is:

1. A parking system, comprising:
a sensing subsystem for detecting an occupancy status of a vehicle parking space, said sensing subsystem providing a real-time occupancy status signal for said vehicle parking space wherein said occupancy status signal includes an occupied mode and an unoccupied mode;
a communications subsystem, coupled to said sensing subsystem, for transmitting said occupancy status signal; and
a management subsystem for receiving said occupancy status signal, said management subsystem initiating a parking transaction for said vehicle parking space automatically upon a mode change of said occupancy status signal from said unoccupied mode to said occupied mode.

2. The parking system of claim 1 wherein said management subsystem includes an authorization controller for applying an authorization ruleset to establish an authorization condition of said vehicle parking space.

3. The parking system of claim 2 wherein said vehicle parking space has an unambiguous identification, wherein said communications subsystem transmits an authorization communication including said identification to said management subsystem, and wherein said authorization controller receives said authorization communication to establish said authorization condition responsive to said authorization ruleset, said occupancy status signal, and said identification.

4. The parking system of claim 3 wherein said authorization communication is initiated from a wireless telephone and includes a payor identification.

5. The parking system of claim 4 wherein said payor identification includes a caller identification signal identifying an account responsible for a parking charge associated with an occupancy of said vehicle parking space.

6. The parking system of claim 5 wherein said parking charge is assessed responsive to a duration of said occupancy status signal in a continuous condition of said occupied mode.

7. The parking system of claim 6 wherein said parking charge is automatically assessed to said credit account upon a mode change of said occupancy status signal to said unoccupied mode.

8. The parking system of claim 7 further comprising a notification system to provide information regarding said parking charge to a user associated with said payor identification.

9. The parking system of claim 2 further comprising a notification subsystem to communicate said authorization condition of said vehicle parking space in real-time.

10. The parking system of claim 9 wherein said notification subsystem communicates wirelessly to an enforcement entity responsible for enforcing a parking status of said vehicle parking space.

11. The parking system of claim 1 wherein said management subsystem closes said parking transaction for said vehicle parking space automatically upon a mode change of said occupancy status signal from said occupied mode to said unoccupied mode.

12. A parking system, comprising:
a sensing subsystem for detecting an occupancy status of a vehicle parking space, said sensing subsystem providing a real-time occupancy status signal for said vehicle parking space wherein said occupancy status signal includes an occupied mode and an unoccupied mode;
a communications subsystem, coupled to said sensing subsystem, for transmitting said occupancy status signal; and
a management subsystem for receiving said occupancy status signal, said management subsystem closing a parking transaction for said vehicle parking space automatically upon a vacating mode change of said occupancy status signal from said occupied mode to said unoccupied mode.

13. The parking system of claim 12 wherein said management subsystem includes an authorization controller for applying an authorization ruleset to establish an authorization condition of said vehicle parking space wherein said parking transaction is initiated automatically upon an occupying mode change of said occupancy status signal from said unoccupied mode to said occupied mode.

14. The parking system of claim 13 wherein said vehicle parking space has an unambiguous identification, wherein said communications subsystem transmits an authorization communication including said identification to said management subsystem, and wherein said authorization controller receives said authorization communication to establish said authorization condition responsive to said authorization ruleset, said occupancy status signal, and said identification.

15. The parking system of claim 14 wherein said authorization communication is initiated from a wireless telephone and includes a payor identification.

16. The parking system of claim 15 wherein said payor identification includes a caller identification signal identifying a credit account responsible for a parking charge associated with an occupancy of said vehicle parking space.

17. The parking system of claim 16 wherein said parking charge is assessed responsive to a duration of said occupancy status signal in a continuous condition of said occupied mode.

18. The parking system of claim 17 wherein said parking charge is automatically assessed to said credit account upon a mode change of said occupancy status signal to said unoccupied mode.

19. The parking system of claim 18 further comprising a notification system to provide information regarding said parking charge to a user associated with said payor identification.

20. The parking system of claim 13 further comprising a notification subsystem to communicate said authorization condition of said vehicle parking space in real-time.

21. The parking system of claim 20 wherein said notification subsystem communicates to an enforcement entity responsible for enforcing a parking status of said vehicle parking space.

22. The parking system of claim 12 wherein said management subsystem opens said parking transaction for said vehicle parking space automatically upon a mode change of said occupancy status signal from said unoccupied mode to said occupied mode.

23. The parking system of claim 12 wherein said management subsystem opens said parking transaction of a particular one parking space upon receipt of an authorization communication in advance of a mode change of said occupancy status signal for said particular one parking space from said unoccupied mode to said occupied mode.

24. A parking system, comprising:
a sensing subsystem for detecting an occupancy status of each of a plurality of individual vehicle parking spaces, said sensing subsystem providing a real-time occupancy status signal for each said vehicle parking space wherein said occupancy status signals each includes an occupied mode and an unoccupied mode for said associated vehicle parking space;
a communications subsystem, coupled to said sensing subsystem, for transmitting said occupancy status signals; and
a management subsystem for receiving said occupancy status signals, said management subsystem initiating a parking transaction for each said vehicle parking space automatically upon a mode change of said associated occupancy status signal from said unoccupied mode to said occupied mode.

25. The parking system of claim 24 wherein said management subsystem closes said parking transaction for each said vehicle parking space automatically upon a mode change of said associated occupancy status signal from said occupied mode to said unoccupied mode.

26. A parking system, comprising:
a sensing subsystem for detecting an occupancy status of each of a plurality of individual vehicle parking spaces, said sensing subsystem providing a real-time occupancy status signal for each said vehicle parking space wherein said occupancy status signals each includes an occupied mode and an unoccupied mode for said associated vehicle parking space;
a communications subsystem, coupled to said sensing subsystem, for transmitting said occupancy status signals; and
a management subsystem for receiving said occupancy status signals, said management subsystem closing a parking transaction for each said vehicle parking space automatically upon a mode change of said associated occupancy status signal from said occupied mode to said unoccupied mode.

27. The parking system of claim 26 wherein said management subsystem opens said parking transaction for each said vehicle parking space automatically upon a mode change of said associated occupancy status signal from said unoccupied mode to said occupied mode.

28. The parking system of claim 27 wherein said management subsystem includes an authorization controller for applying an authorization ruleset to establish an authorization condition of each said vehicle parking space wherein said authorization ruleset dynamically determines a parking rate upon opening said parking transaction.

29. A method, the method comprising:
a) detecting in real-time an occupancy status of each of a plurality of vehicle parking spaces;
b) communicating said occupancy status of each of said plurality of vehicle parking spaces to a centralized management facility; and
c) initiating a parking transaction for each said vehicle parking space automatically upon a mode change of said associated occupancy status from an unoccupied mode to an occupied mode.

30. The method of claim 29 further comprising:
d) closing said parking transaction for each said vehicle parking space automatically upon a mode change of said associated occupancy status from said occupied mode to said unoccupied mode.

31. A method, the method comprising:
a) detecting in real-time an occupancy status of each of a plurality of vehicle parking spaces;
b) communicating said occupancy status of each of said plurality of vehicle parking spaces to a centralized management facility; and
c) closing a parking transaction for each said vehicle parking space automatically upon a mode change of said associated occupancy status from an occupied mode to an unoccupied mode.

32. The method of claim 31 further comprising:
d) initiating said parking transaction for each said vehicle parking space automatically upon a mode change of said associated occupancy status from said unoccupied mode to said occupied mode.

33. A computer program product comprising a computer readable medium carrying program instructions for managing a collection of parking spaces when executed using a computing system, the executed program instructions executing a method, the method comprising:
a) detecting in real-time an occupancy status of each of a plurality of vehicle parking spaces;
b) communicating said occupancy status of each of said plurality of vehicle parking spaces to a centralized management facility; and
c) closing a parking transaction for each said vehicle parking space automatically upon a mode change of said associated occupancy status from an occupied mode to an unoccupied mode.
